(19) United States
(12) Patent Application Publication
(10) Pub. No.: US 2011/0304688 A1
(43) Pub. Date: Dec. 15, 2011

(54) PANORAMIC CAMERA AND METHOD FOR CAPTURING PANORAMIC PHOTOS

(75) Inventor: CHI-SHENG GE, Tu-Cheng (TW)

(73) Assignee: HON HAI PRECISION INDUSTRY CO., LTD., Tu-Cheng (TW)

(21) Appl. No.: 12/846,761

(22) Filed: Jul. 29, 2010

(30) Foreign Application Priority Data
Jun. 9, 2010 (CN) 201010195570.2

(51) Int. Cl. H04N 7/00

(52) U.S. Cl. 348/36; 348/E07.091

(57) ABSTRACT

A panoramic camera includes a camera module configured to capture an initial photo and a subsequent photo, an electronic compass, a memory unit, a control unit, and a stitching unit. The electronic compass is attached to the camera module and configured to measure a current orientation of the camera module. The memory unit is connected to the camera module and configured to store the initial photo and the subsequent photo. The control unit is connected between the electronic compass and the camera module. The control unit is configured to generate a capturing signal to trigger the camera module to capture the subsequent photo if determining that the camera module rotates through the angle of view thereof from an initial orientation when the initial photo is captured. The stitching unit is connected to the memory unit and configured to stitch the initial photo and the subsequent photo.

### BACKGROUND

1. Technical Field

The present disclosure relates to capturing technology, and particularly, to a panoramic camera and a method for capturing panoramic photos.

2. Description of Related Art

Conventionally, to capture a panoramic photo, users generally point their cameras at the left or right end of a view and capture several pictures in succession while panning the camera. Then the pictures are stitched together during processing, for example in the case of digital pictures, special software is used which is complicated and difficult to master to eliminate overlapping areas. However, little if anything can be done for any gaps between views captured in the pictures.

Therefore, it is desirable to provide a new panoramic camera which can overcome the above-mentioned limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure.

FIG. 1 is a functional block diagram of a panoramic camera, according to an exemplary embodiment.

FIG. 2 is a flow chart of a method for capturing a panoramic photo, according to an exemplary embodiment.

### DETAILED DESCRIPTION

Embodiments of the present disclosure will now be described in detail with reference to the drawings.

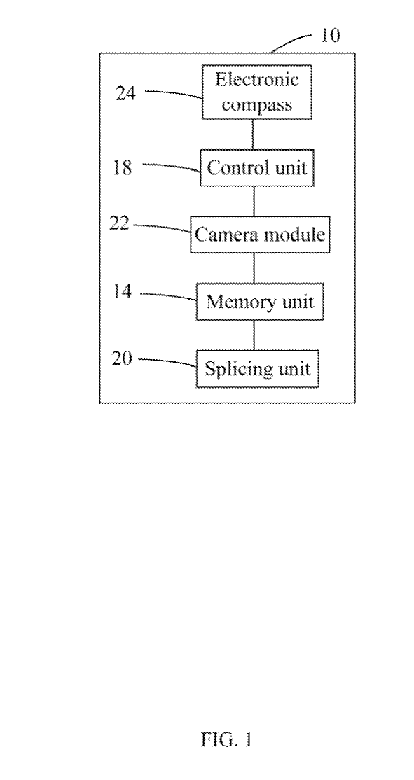

Referring to FIG. 1, a panoramic camera 10, according to an exemplary embodiment, includes a camera module 22, an electronic compass 24, a memory unit 14, a control unit 18, and a stitching unit 20.

The camera module 22 is used for capturing photos, and has a fixed angle of view as one of its characters. In particular, the camera module 22 can be triggered to capture photos by use of a shutter button (not shown) on the panoramic camera 10, and by a capturing signal generated by the control unit 18 (see below).

The electronic compass 24 is attached to the camera module 22 and thus can rotate with the camera module 22 to measure a current orientation of the camera module 22.

The memory unit 14 is connected to the camera module 22 to store the photos. The photos may be temporarily stored in the memory unit 14 and erased if desired once the photos have been stitched together to form a panoramic photo that can be stored in the memory unit 14.

The control unit 18 is connected to the electronic compass 24 and the camera module 22. The control unit 18 stores the angle of view of the camera module 22, and is configured to read the current orientation of the camera module 22 from the electronic compass 24. The control unit 18 generates a capturing signal when the panoramic camera 10 rotates through multiple angles of view from an initial orientation when capturing a panoramic photo, and sends the capturing signal to the camera module 22. The camera module 22 is triggered to capture a photo by the capturing signal. As such, the camera module 22 is triggered to capture photos in succession according to the changing angle of view by the capturing signals, thereby avoiding gaps in the view of adjacent shooting angles and minimize overlapping.

The stitching unit 20 is connected to the memory unit 14 and configured to stitch the photos into a panoramic photo according to the sequence in which the photos were captured and the rotation direction of the camera module 22. In detail, for a two photo example, when the camera module 22 rotates clockwise, the stitching unit 20 stitches the right edge of the initial photo to the left edge of the second photo. When the panoramic camera 10 rotates counterclockwise, the stitching unit 20 stitches the left edge of the initial photo to the right edge of the second photo.

Commonly, camera modules may have an angle of view of about 40 to 50 degrees. During the process of capturing a panoramic photo, the camera module 22 should rotate beyond the 40 to 50 degrees, and capture consecutive photos. In this embodiment, the angle of view of the camera module 22 is 46 degrees. The camera module 22 rotates clockwise and captures three photos to form a panoramic photo (that is, the total field of view of the panoramic photo is about 138 degrees).

In operation, for a three photo panoramic photo embodiment, users press the shutter button on the panoramic camera 10 to capture an initial photo when beginning to capture a panoramic photo. The control unit 18 then reads an initial orientation of the camera module 22 from the electronic compass 24. The initial orientation defines the orientation direction the camera module 22 faced when the initial photo was captured. At the same time, the control unit 18 reads the angle of view of the camera module 22.

The camera module 22 may be rotated clockwise to get a second photo. During rotation, the control unit 18 continuously reads the current orientation of the camera module 22. When the panoramic camera 10 rotates 46 degrees from the initial orientation, the control unit 18 generates and transmits a capturing signal to the camera module 22. The camera module 22 is then triggered to capture a second photo.

The camera module 22 may then be rotated clockwise a second time, when the panoramic camera 10 has rotated 92 degrees from the initial orientation, in other words, twice the angle of view from the initial orientation, the control unit 18 generates and transmits another capturing signal to the camera module 22 to capture a third photo.

The stitching unit 20 stitches the first, the second, and the third photos, arranged according to the sequence in which these three photos were captured, into a panoramic photo with reference to the rotation direction of the camera module 22 (clockwise or counter clockwise). For this embodiment of three photos, stitching the right edge of the initial photo to the left edge of the second photo, and stitching the right edge of the second photo to the left edge of the third photo forms the panoramic photo.

It will be understood that the number of the photos that are to be stitched into a panoramic photo is not limited to three. For example, when the camera module 22 is a wild-angle camera module, two photos may be captured to form a panoramic photo. Generally, the total angle of view of the panoramic photo is less than 360 degrees, which means that the number of the photos that are to be stitched into a panoramic photo is not more than the integral quotient of 360 degrees divided by the angle of view of the camera module 22.

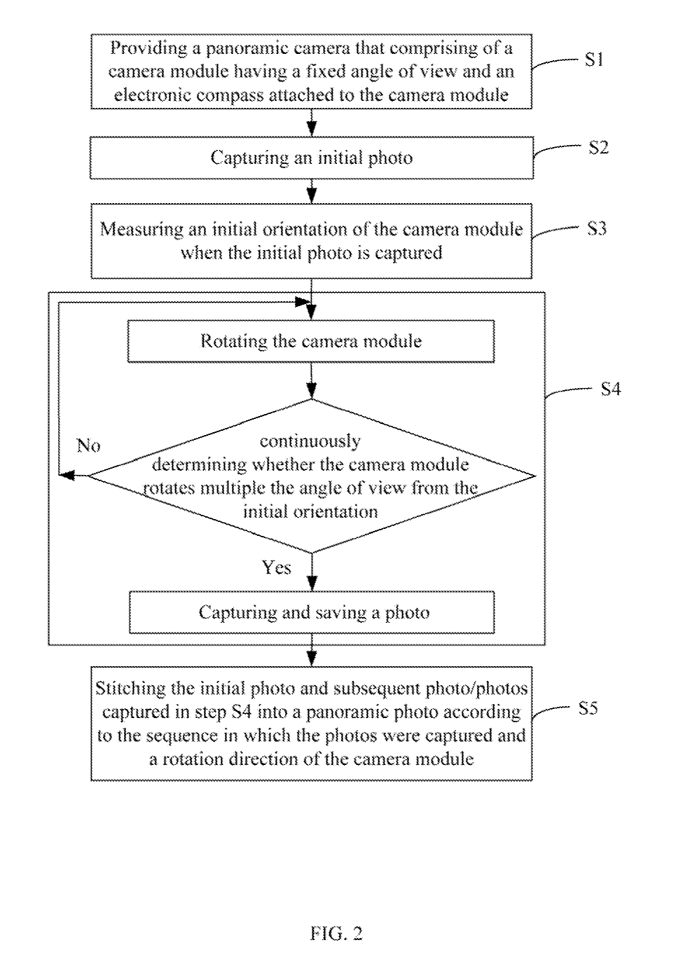

Referring to FIG. 2, a method for capturing a panoramic photo, according to an exemplary embodiment, includes the following steps.

S1: Providing a panoramic camera 10 that includes a camera module 22 having a fixed angle of view and a electronic compass 24 attached to the camera module 22.

S2: Capturing a initial photo.

S3: Measuring an initial orientation of the camera module 22 when the initial photo is captured.

S4: Rotating the camera module 22, and continuously determining whether the camera module 22 rotates multiple angles of view from the initial orientation; if not, keeping on rotating, otherwise, capturing and saving a photo; wherein it is preferred the multiplier of the angle of view is less than the margin of the integral quotient of 360 degrees divided by the angle of view subtracting 1.

S5: Stitching the initial photo and subsequent photo/photos captured in step S4 into a panoramic photo according to the sequence in which the photos were captured and the rotation direction of the camera module 22.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. A panoramic camera, comprising:
a camera module having a fixed angle of view, and configured to capture an initial photo and a subsequent photo;
an electronic compass attached to the camera module, and configured to measure a current orientation of the camera module;
a memory unit connected to the camera module, and configured to store the initial photo and the subsequent photo;
a control unit connected between the electronic compass and the camera module, and configured to generate a capturing signal to trigger the camera module to capture the subsequent photo if determining that the camera module rotates through the angle of view thereof from an initial orientation when the initial photo is captured, based on the current orientation from the electronic compass; and
a stitching unit connected to the memory unit, and configured to stitch the initial photo and the subsequent photo according to the sequence in which the photos are captured and the rotation direction of the camera module.

2. The panoramic camera of claim 1, wherein when the camera module rotates clockwise, the stitching unit stitches the right edge of the initial photo to the left edge of the subsequent photo.

3. The panoramic camera of claim 1, wherein when the camera module rotates counterclockwise, the stitching unit stitches the left edge of the initial photo to the right edge of the subsequent photo.

4. A method for capturing a panoramic photo, comprising:
providing a panoramic camera that comprises a camera module having a fixed angle of view and an electronic compass attached to the camera module;
capturing an initial photo;
measuring an initial orientation of the camera module when the initial photo is captured;
rotating the camera module, and continuously determining whether the camera module rotates the angle of view thereof from the initial orientation; if not, keeping on rotating, otherwise, capturing and saving a subsequent photo; and
stitching the initial photo and the subsequent photo according to the sequence in which the photos were captured and a rotation direction of the camera module.

5. The method of claim 4, wherein when the camera module rotates clockwise, the right edge of the initial photo is spliced to the left edge of the subsequent photo.

6. The method of claim 4, wherein when the camera module rotates counterclockwise, the left edge of the initial photo is spliced to the right edge of the subsequent photo.
